(19) United States
(12) Patent Application Publication
(10) Pub. No.: US 2022/0346088 A1
(43) Pub. Date: Oct. 27, 2022

(54) MULTIPLEXING SCHEDULING METHOD FOR IAB NETWORK AND IAB NODE

(71) Applicant: VIVO MOBILE COMMUNICATION CO., LTD., Guangdong (CN)

(72) Inventor: Jinhua LIU, Guangdong (CN)

(21) Appl. No.: 17/861,348

(22) Filed: Jul. 11, 2022

Related U.S. Application Data
(63) Continuation of application No. PCT/CN2021/076447, filed on Feb. 10, 2021.

(30) Foreign Application Priority Data
Feb. 11, 2020 (CN) 202010087407.8

(51) Int. Cl. H04W 72/04

(52) U.S. Cl. CPC H04W 72/0426; H04W 72/0446; H04W 88/08

(57) ABSTRACT

Embodiments of the present invention disclose a multiplexing scheduling method for IAB network and an IAB node. The method includes: determining pre-scheduling information between a first hop and a second hop; receiving activation signaling sent by a second IAB node; and after activating multiplexing scheduling between the first hop and the second hop based on the activation signaling, performing multiplexing scheduling based on the pre-scheduling information, where a first IAB node is used to schedule data transmission on the first hop, and the second IAB node is a parent IAB node of the first IAB node and is used to schedule data transmission on the second hop.

### CROSS-REFERENCE TO RELATED APPLICATIONS

The present application is a continuation application of PCT International Application No. PCT/CN2021/076447 filed on Feb. 10, 2021, which claims a priority to Chinese Patent Application No. 202010087407.8, filed with the Chinese Patent Office on Feb. 11, 2020 and entitled “MULTIPLEXING SCHEDULING METHOD FOR IAB NETWORK AND IAB NODE”, which are incorporated herein by reference in their entireties.

### TECHNICAL FIELD

The present invention relates to the communications field, and in particular, to a multiplexing scheduling method for IAB network and an IAB node.

### BACKGROUND

At present, in a new radio (NR) system, Integrated Access and Backhaul (IAB) may provide extended coverage and enhanced capacity for NR cells. An access node that supports radio access of user equipment (UE, also referred to as a terminal device) and performs wireless backhaul of data is called an IAB node (IABN). An access node that provides a wireless backhaul function for the IAB node to implement connection between the UE and a core network (CN) is called a donor IAB node. Wired transmission is performed between the donor IAB and core network. UE data is transmitted between the UE and an access node via a radio access link, and UE data is transmitted between access nodes via a wireless backhaul link.

In an IAB network architecture that supports separated deployment of centralized units (CU) and distributed units (DU), an IAB node IABN) includes a DU function part and a mobile termination (MT) function part. Relying on the MT function part, an access node (that is, an IABN) may find an upstream access node (that is, a parent IABN, P-IABN) and establishes a wireless backhaul link to a DU of the upstream access node. After an IAB node has established a complete backhaul link, the IAB node starts its DU function and the DU provides cell services, that is, the DU may provide access services for UEs. A self-backhaul loop includes a donor IAB node. DUs of all IAB nodes in the self-backhaul loop may be connected to a CU node, that is, a CU function part of the donor IAB node.

In an IAB network, an across-hop scheduling relationship based on spatial division multiplexing (SDM), frequency division multiplexing (FDM), or co-frequency co-time full duplex (CCFD) may be implemented. However, whether multiplexing is applied affects parameters between two hops, such as transmission interference, power distribution, and time-sequence adjustment. Data transmission between two hops is scheduled by different nodes; as a result, schedulers of two scheduling nodes cannot predict parameters required for transmission scheduling, thereby degrading transmission performance.

### SUMMARY

According to a first aspect, an embodiment of the present invention provides a multiplexing scheduling method for IAB network applied to a first IAB node. The method includes: determining pre-scheduling information between a first hop and a second hop; receiving activation signaling sent by a second IAB node; and after activating multiplexing scheduling between the first hop and the second hop based on the activation signaling, performing multiplexing scheduling based on the pre-scheduling information, where the first IAB node is used to schedule data transmission on the first hop, and the second IAB node is a parent IAB node of the first IAB node and is used to schedule data transmission on the second hop.

According to a second aspect, an embodiment of the present invention provides a first IAB node. The first IAB node includes: a determining module, configured to determine pre-scheduling information between a first hop and a second hop; a receiving module, configured to receive activation signaling sent by a second IAB node; and a scheduling module, configured to, after activating multiplexing scheduling between the first hop and the second hop based on the activation signaling, perform multiplexing scheduling based on the pre-scheduling information, where the first IAB node is used to schedule data transmission on the first hop, and the second IAB node is a parent IAB node of the first IAB node and is used to schedule data transmission on the second hop.

According to a third aspect, an embodiment of the present invention provides a first IAB node, including a memory, a processor, and a computer program stored in the memory and capable of running on the processor, where when the computer program is executed by the processor, the steps of the method according to the first aspect are implemented.

According to a fourth aspect, an embodiment of the present invention provides a computer-readable storage medium, where a computer program is stored in the computer-readable storage medium, and when the computer program is executed by a processor, the steps of the method according to the first aspect are implemented.

According to a fifth aspect, an embodiment of the present invention provides a multiplexing scheduling method for IAB network applied to a second IAB node. The method includes: sending activation signaling to a first IAB node, where the activation signaling is used by the first IAB node to activate multiplexing scheduling between a first hop and a second hop, the first IAB node is used to schedule data transmission on the first hop, and the second IAB node is a parent IAB node of the first IAB node and is used to schedule data transmission on the second hop.

According to a sixth aspect, an embodiment of the present invention provides a second IAB node. The second IAB node includes: a sending module, configured to send activation signaling to a first IAB node, where the activation signaling is used by the first IAB node to activate multiplexing scheduling between a first hop and a second hop, the first IAB node is used to schedule data transmission on the first hop, and the second IAB node is a parent IAB node of the first IAB node and is used to schedule data transmission on the second hop.

According to a seventh aspect, an embodiment of the present invention provides a second IAB node, including a memory, a processor, and a computer program stored in the memory and capable of running on the processor, where when the computer program is executed by the processor, the steps of the method according to the fifth aspect are implemented.

According to an eighth aspect, an embodiment of the present invention provides a computer-readable storage medium, where a computer program is stored in the computer-readable storage medium, and when the computer program is executed by a processor, the steps of the method according to the fifth aspect are implemented.

### BRIEF DESCRIPTION OF DRAWINGS

The drawings described herein are used to provide a further understanding about the present invention, and constitute a part of the present invention. Exemplary embodiments of the present invention and descriptions thereof are used to explain the present invention, but do not constitute any inappropriate limitation on the present invention. In the accompanying drawings:

FIG. 1 is a schematic diagram of an across-hop multiplexing scheduling relationship in an IAB network according to an embodiment of the present invention;

FIG. 2 is a schematic flowchart of a multiplexing scheduling method for IAB network according to an embodiment of the present invention;

FIG. 3 is a schematic diagram of a manner of determining a starting time point of multiplexing scheduling according to an embodiment of the present invention;

FIG. 4 is a schematic diagram of another manner of determining a starting time point of multiplexing scheduling according to an embodiment of the present invention;

FIG. 5 is a schematic flowchart of another multiplexing scheduling method for IAB network according to an embodiment of the present invention;

FIG. 6 is a schematic structural diagram of a first IAB node according to an embodiment of the present invention;

FIG. 7 is a schematic structural diagram of a second IAB node according to an embodiment of the present invention;

FIG. 8 is a schematic structural diagram of another first IAB node according to an embodiment of the present invention; and

FIG. 9 is a schematic structural diagram of another second IAB node according to an embodiment of the present invention.

### DESCRIPTION OF EMBODIMENTS

The following clearly and describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

The technical solutions of the present invention may be applied to various communications systems, for example, a global system for mobile communications (GSM), a code division multiple access (CDMA) system, a wideband code division multiple access (WCDMA) system, a general packet radio service (GPRS) system, a long term evolution/long term evolution advanced (LTE-A) system, and an NR system.

User equipment (UE), also referred to as a mobile terminal, a mobile user device, or the like, may communicate with one or more core networks through a radio access network (RAN). The user equipment may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network.

A network device, also referred to as a base station, may be a base transceiver station (BTS) in GSM or CDMA, a NodeB in WCDMA, an evolved NodeB (eNB or e-NodeB) in LTE, or a 5G base station (gNB).

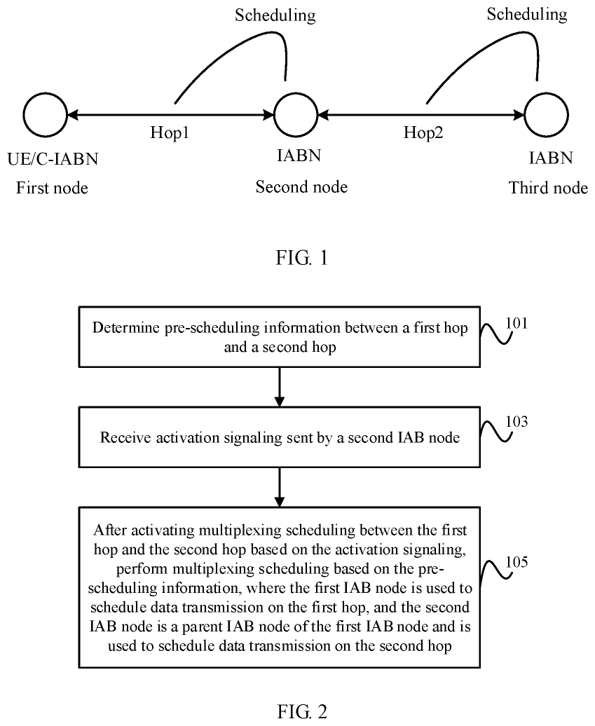

In the embodiments of the present invention, when SDM, FDM, or CCFD is used across hops in an IAB network, user equipment (UE, which may also be referred to as a terminal device) or a child IAB node (C-IABN, which may be referred to as a first node), a local IAB node (referred to as a second node or a first IAB node), and a parent IAB node (P-IABN, which is referred to as a third node or a second IAB node) of the local IAB node are involved. Data transmission on hops is scheduled by different IAB nodes. That is, data transmission on Hop1 (that is, a first hop) between the first node and the second node is scheduled by the second node, that is, the first IAB node, and data transmission on Hop2 (that is, a second hop) between the second node and the third node is scheduled by the third node, that is, the second IAB node, as shown in FIG. 1.

In spatial division multiplexing (SDM), an IAB node receives a physical downlink shared channel (PDSCH) from its parent IAB node and receives a physical uplink shared channel (PDSCH) from its child IAB node or UE at the same time on the same time-frequency resource, or an IAB node sends a PUSCH to its parent IAB node and sends a PDSCH to its child IAB node or UE at the same time on the same time-frequency resource.

In frequency division multiplexing (FDM), an IAB node receives a PDSCH from its parent IAB node and receives a PUSCH from its child IAB node or UE at the same time on different frequency resources, or an IAB node sends a PUSCH to its parent IAB node and sends a PDSCH to its child IAB node or UE at the same time on different frequency resources.

In co-frequency co-time full duplex, an IAB node receives a PDSCH from its parent IAB node and sends a PDSCH to its child IAB node or UE at the same time on the same time-frequency resource, or an IAB node sends a PUSCH to its parent IAB node and receives a PUSCH from its child IAB node or UE at the same time on the same time-frequency resource. Multiple panel transmission reception (MPTR) is a technology in which an IAB node uses different antenna modules (panel) to perform transmission and reception. For example, the IAB node has two antenna modules, one module used for receiving while the other module used for sending. A high degree of isolation may be present between MPTR transceiver antenna modules, which may reduce an interference of sending on receiving to some extent.

However, whether multiplexing is applied affects parameters between two hops, such as transmission interference, power distribution, and time-sequence adjustment. In a case that data transmission between two hops is scheduled by different nodes, schedulers of two scheduling nodes may be unable to predict parameters required for transmission scheduling (such as interference, power distribution, and time sequence adjustment). Referring to FIG. 1, specifically, when a first IAB node schedules data transmission on Hop1, the first IAB node is not aware whether a second IAB node has scheduled data transmission on Hop2 and its scheduling parameters. Likewise, when the second IAB node schedules data transmission on Hop2, the second IAB node is neither aware whether the first IAB node has scheduled data transmission on Hop1 and its scheduling parameters. The scheduling parameters may include information such as a time-frequency resource, a demodulation reference signal (DMRS), a modulation and coding scheme (MCS), a rank (RANK), and RVI. In this case, at least an issue described in (1) and (2) may occur.

(1) Interference on reception of the first IAB node cannot be determined. For example, for the MPTR technology, if the first IAB node has both Hop1 uplink receive (ULRX) and Hop2 uplink transmit (ULTX), Hop1 ULRX may be heavily interfered and requires conservative scheduling. If only Hop1 ULRX is available, conservative scheduling (for example, backward scheduling based on an additional signal-to-noise and interference ratio (SINR)) is not required, and normal scheduling is sufficient. If the first IAB node is not aware whether Hop2 ULTX has been performed, the first IAB node cannot accurately predict interference on Hop1 ULRX and therefore cannot accurately determine scheduling parameters, which degrades transmission performance.

(2) A power distribution status of the first IAB node cannot be determined. For example, for SDMTX, if the first IAB node has both Hop1 downlink transmit (DL TX) and Hop2 ULTX, and the first IAB node has only a transmit radio frequency (RF) channel, a total transmit power of the first IAB node shall be distributed between Hop1 DLTX and Hop2 ULTX; if the first IAB node has only Hop1 DLTX or Hop2 ULTX, all transmit power may be used for Hop1 DLTX or Hop2 ULTX. If the first IAB node and the second IAB node are unaware of scheduling of each other, they cannot determine available transmit power.

Therefore, to resolve the foregoing issue, the multiplexing scheduling solution for IAB network in the embodiments of the present invention is proposed.

The technical solutions provided by the embodiments of the present invention are hereinafter described in detail with reference to accompanying drawings.

Referring to FIG. 2, an embodiment of the present invention provides a multiplexing scheduling method for IAB network that is executed by a first IAB node in an IAB network. The method includes the following steps.

Step 101: Determine pre-scheduling information between a first hop and a second hop.

Optionally, the pre-scheduling information may include at least multiplexing resource information and a multiplexing manner.

Optionally, the multiplexing resource information includes at least one of the following: a time length for using multiplexing scheduling; a frequency range for using multiplexing scheduling; and a starting time point of multiplexing scheduling.

Optionally, in the multiplexing scheduling method for IAB network according to this embodiment of the present invention, the pre-scheduling information may further include power control information. The power control information may include a power offset, a maximum power of an MT of the first IAB node, a maximum power of a DU of the first IAB node, and the like, which helps accurately determine a power distribution status on the IAB node.

Optionally, the multiplexing manner may include one of the following (1) to (6).

(1) Spatial division multiplexing-based transmit SDM TX multiplexing. That is, both Hop1 DLTX (that is, DLTX on the first hop) and Hop2 ULTX (that ULTX on the second hop) are available. In this case, power distribution of the first IAB node between two hops is considered for scheduling of two IAB nodes.

(2) Spatial division multiplexing-based receive SDM RX multiplexing. That is, both Hop1 ULRX and Hop2 DLRX are available. In this case, interference of the first IAB node between two hops is considered for scheduling of two IAB nodes.

(3) Frequency division multiplexing-based transmit FDM TX multiplexing. That is, one part of frequency is used for Hop1 DLTX and the other part of frequency is used for Hop2 ULTX. In this case, frequency distribution between two hops is considered for scheduling of two IAB nodes.

(4) Frequency division multiplexing-based receive FDM RX multiplexing. That is, one part of frequency is used for Hop1 ULRX and the other part of frequency is used for Hop2 DLRX. In this case, frequency distribution between two hops is considered for scheduling of two IAB nodes.

(5) Uplink transmit and receive multiplexing based on co-frequency co-time full duplex CCFD, such as MPTR UL. That is, both Hop1 ULRX and Hop2 ULTX are available. In this case, interference of Hop2 ULTX on Hop1 ULRX is considered for scheduling of two IAB nodes.

(6) Downlink transmit and receive multiplexing based on co-frequency co-time full duplex CCFD, such as MPTR DL. That is, both Hop1 DLTX and Hop2 DL RX are available. In this case, interference of Hop1 DLTX on Hop2 ULRX is considered for scheduling of two IAB nodes.

Step 103: Receive activation signaling sent by a second IAB node.

Optionally, the activation signaling may be carried by one of the following: a physical downlink control channel (PDCCH); a medium access control control element (MAC CE); and a backhaul adaptation protocol control protocol data unit (BAP control PDU).

Step 105: After activating multiplexing scheduling between the first hop and the second hop based on the activation signaling, perform multiplexing scheduling based on the pre-scheduling information, where the first IAB node is used to schedule data transmission on the first hop, and the second IAB node is a parent IAB node of the first IAB node and is used to schedule data transmission on the second hop.

In other words, the first IAB node may schedule data transmission on the first hop on a preconfigured time-frequency resource in a configured multiplexing manner between a previous hop and a next hop (that is, the first hop and the second hop).

In this embodiment of the present invention, in a self-backhaul loop of an IAB network, in a case that the first IAB node for scheduling the first hop determines the pre-scheduling information between the first hop and the second hop, the first IAB node may perform multiplexing scheduling between the first hop and the second hop based on the activation signaling received from its parent IAB node, that is, the second IAB node. The first IAB node may perform multiplexing scheduling based on the pre-scheduling information. This not only enriches manners of activating multiplexing scheduling across hops in the IAB network, but also helps determine interference on reception of the first IAB node. In this way, scheduling parameters can be accurately determined to further accurately determine a power distribution status on IAB nodes, thereby improving adaptive performance of a radio backhaul link, reducing transmission latency, and improving spectrum efficiency.

Optionally, in step 101 of the multiplexing scheduling method for IAB network in this embodiment of the present invention, the pre-scheduling information may be determined in different manners, including but not limited to the following specific embodiments:

### Specific Embodiment 1

In the specific embodiment 1, step 101 may be executed as follows: obtaining the pre-scheduling information determined by the second IAB node.

It may be understood that the pre-scheduling information used for multiplexing scheduling between the first hop and the second hop is configured by the parent IAB node of the first IAB node, which is the second IAB node.

Optionally, in the specific embodiment 1, the pre-scheduling information is carried by one of the following: a PDCCH, a MAC CE, and a BAP control PDU.

Optionally, in the specific embodiment 1, if multiplexing resource information in the pre-scheduling information includes a starting time point of multiplexing scheduling, the starting time point of multiplexing scheduling is determined based on one of the following (1) to (3):

(1) A receiving time of a PDCCH, a MAC CE, or a BAP control PDU.

In other words, the starting time point of multiplexing scheduling corresponds to the receiving time of the PDCCH, the MAC CE, or the BAP control PDU, and optionally, corresponds to a starting or ending time point of a slot in which the PDCCH, MAC CE, or BAP control PDU is located.

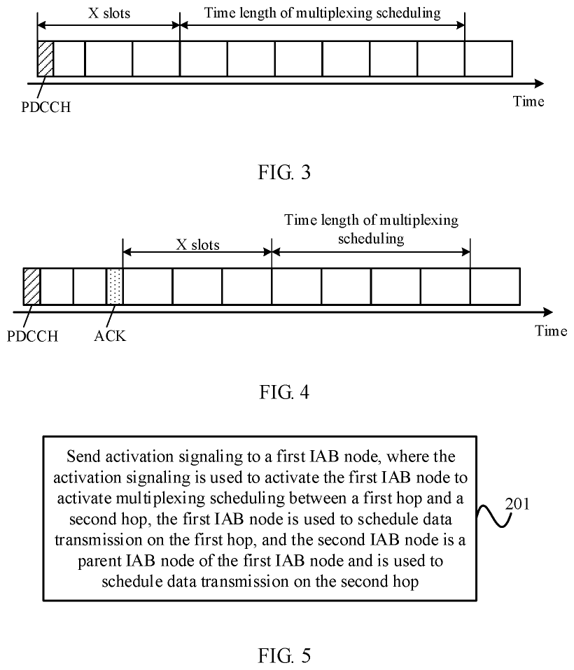

For example, referring to FIG. 3, multiplexing scheduling between the first hop and the second hop takes effect in X slots after PDCCH reception, that is, multiplexing scheduling starts at a time that is X slots after PDCCH reception.

(2) A sending time of an acknowledgement signal corresponding to reception of thee PDCCH, the MAC CE, or the BAP control PDU.

In other words, the starting time point of multiplexing scheduling corresponds to the sending time of an acknowledgement signal corresponding to reception of the PDCCH, MAC CE, or BAP control PDU, and optionally, corresponds to a ending time point of a slot in which the sending time of the acknowledgement signal is located.

For example, referring to FIG. 4, multiplexing scheduling between the first hop and the second hop takes effect in X slots after sending of the acknowledgement signal (ACK), that is, multiplexing scheduling starts at a time that is X slots after the sending time of the acknowledgement signal.

(3) Indication information carried by the PDCCH, the MAC CE, or the BAP control PDU.

Optionally, the starting time point of multiplexing scheduling is determined based on indication displayed on carried by the PDCCH, the MAC CE, or the BAP control PDU.

For example, the multiplexing scheduling based on the indication of the PDCCH is activated in X slots after PDCCH reception.

### Specific Embodiment 2

In the specific embodiment 2, step 101 may be executed as follows: obtain the pre-scheduling information configured by a centralized unit (CU).

It may be understood that the pre-scheduling information used for multiplexing scheduling between the first hop and the second hop is configured by the CU in the self-backhaul loop.

Optionally, in the specific embodiment 2, the pre-scheduling information is carried by one of the following: radio resource control (RRC) signaling or FLAP (F1 Application Protocol) signaling. The centralized unit (CU) may configure a DU function part of the IAB node according to the F1-AP protocol and configure an MT part of the IAB node according to an RRC protocol.

Optionally, the multiplexing scheduling method for IAB network in this embodiment of the present invention may further include an operation of deactivating the multiplexing scheduling between the first hop and the second hop. After the multiplexing scheduling is deactivated, multiplexing scheduling is no longer performed for the first IAB node and the second IAB node. The deactivation operation is described with reference to the following specific embodiments. It should be noted that specific embodiments include but are not limited to the following specific embodiments.

### Specific Embodiment 1

In the specific embodiment 1, the multiplexing scheduling method for IAB network according to this embodiment of the present invention may further include: receiving deactivation signaling sent by the second IAB node, where the deactivation signaling is used to indicate deactivating the multiplexing scheduling.

It may be understood that the first IAB node deactivates the multiplexing scheduling based on the deactivation signaling sent by the second IAB node.

Optionally, in the specific embodiment 1, the deactivation signaling is carried by one of the following: a physical downlink control channel PDCCH, a medium access control control element MAC CE, and a BAP control PDU.

### Specific Embodiment 2

In the specific embodiment 2, the multiplexing scheduling method for IAB network according to this embodiment of the present invention may further include: determining, based on received target scheduling information of the second IAB node on the second hop, whether to deactivate the multiplexing scheduling.

It may be understood that the first IAB node determines, based on a received scheduling status of the second IAB node on the second hop, whether to deactivate the multiplexing scheduling. The target scheduling information is used to reflect the scheduling status of the second IAB node on the second hop. Optionally, the target scheduling information includes duration of data transmission of the second IAB node on an unscheduled multiplexing resource on the second hop. In an example, the MT of the first IAB node starts a timer after each transmit (or receive) scheduled by the second IAB node on the multiplexing resource. If the timer expires, the first IAB node determines to deactivate the multiplexing scheduling.

### Specific Embodiment 3

In the specific embodiment 3, the multiplexing scheduling in the multiplexing scheduling method for IAB network according to this embodiment of the present invention is deactivated after bandwidth part (BWP) switching.

It may be understood that the first IAB node may implement autonomous deactivation of the multiplexing scheduling after BWP switching.

Referring to FIG. 5, an embodiment of the present invention provides a multiplexing scheduling method for IAB network that is executed by a second IAB node in an IAB network. The method includes the following steps.

Step 201: Send activation signaling to a first IAB node, where the activation signaling is used by the first IAB node to activate multiplexing scheduling between a first hop and a second hop, the first IAB node is used to schedule data transmission on the first hop, and the second IAB node is a parent IAB node of the first IAB node and is used to schedule data transmission on the second hop.

In this embodiment of the present invention, in a self-backhaul loop of an IAB network, in a case that the first IAB node for scheduling the first hop determines pre-scheduling information between the first hop and the second hop, a parent IAB node of the first IAB node, that is, the second IAB node, may send the activation signaling to the first IAB node so that the first IAB node activates the multiplexing scheduling between the first hop and the second hop based on the activation signaling. This not only enriches manners of activating multiplexing scheduling across hops in the IAB network, but also helps determine interference on reception of the first IAB node. In this way, scheduling parameters can be accurately determined to further accurately determine a power distribution status on IAB nodes, thereby improving adaptive performance of a radio backhaul link, reducing transmission latency, and improving spectrum efficiency.

Optionally, before step 201, the multiplexing scheduling method for IAB network according to this embodiment of the present invention may further include: sending pre-scheduling information to the first IAB node, where the pre-scheduling information is used to configure the first IAB node to perform multiplexing scheduling between the first hop and the second hop.

Optionally, the pre-scheduling information may include at least multiplexing resource information and a multiplexing manner.

Optionally, the multiplexing resource information includes at least one of the following: a time length for using multiplexing scheduling; a frequency range for using multiplexing scheduling; and a starting time point of multiplexing scheduling.

Optionally, in the multiplexing scheduling method for IAB network according to this embodiment of the present invention, the pre-scheduling information may further include power control information. The power control information may include a power offset, a maximum power of an MT of the first IAB node, a maximum power of a DU of the first IAB node, and the like, which helps accurately determine power distribution on the IAB node.

Optionally, the multiplexing manner may include one of the following (1) to (6).

(1) Spatial division multiplexing-based transmit SDM TX multiplexing. That is, both Hop1 DLTX (that is, DLTX on the first hop) and Hop2 ULTX (that is, ULTX on the second hop) are available. In this case, power distribution of the first IAB node between two hops is considered for scheduling of two IAB nodes.

(2) Spatial division multiplexing-based receive SDM RX multiplexing. That is, both Hop1 ULRX and Hop2 DLRX are available. In this case, interference of the first IAB node between two hops is considered for scheduling of two IAB nodes.

(3) Frequency division multiplexing-based transmit FDM TX multiplexing. That is, one part of frequency is used for Hop1 DLTX and the other part of frequency is used for Hop2 ULTX. In this case, frequency distribution between two hops is considered for scheduling of two IAB nodes.

(4) Frequency division multiplexing-based receive FDM RX multiplexing. That is, one part of frequency is used for Hop1 ULRX and the other part of frequency is used for Hop2 DLRX. In this case, frequency distribution between two hops is considered for scheduling of two IAB nodes.

(5) Uplink transmit and receive multiplexing based on co-frequency co-time full duplex CCFD, such as MPTR UL. That is, both Hop1 ULRX and Hop2 ULTX are available. In this case, interference of Hop2 ULTX on Hop1 ULRX is considered for scheduling of two IAB nodes.

(6) Downlink transmit and receive multiplexing based on co-frequency co-time full duplex CCFD, such as MPTR DL. That is, both Hop1 DLTX and Hop2 DL RX are available. In this case, interference of Hop1 DLTX on Hop2 ULRX is considered for scheduling of two IAB nodes.

Optionally, the multiplexing scheduling method for IAB network according to this embodiment of the present invention may further include: performing multiplexing scheduling between the first hop and the second hop based on the pre-scheduling information.

The pre-scheduling information may be configured by a centralized unit CU, in addition to the second IAB node. Specifically, the pre-scheduling information may be carried based on RRC signaling or F1AP signaling. In other words, the second IAB node may schedule data transmission on the second hop on a preconfigured time-frequency resource in a configured multiplexing manner between a previous hop and a next hop (that is, the first hop and the second hop). The second IAB node automatically activates the multiplexing scheduling on the preconfigured time-frequency resource or activates the multiplexing scheduling by using a PDCCH, MAC CE, or BAP control PDU.

Optionally, in the multiplexing scheduling method for IAB network according to this embodiment of the present invention, the activation signaling and pre-scheduling information are carried by one of the following: a PDCCH, a MAC CE, and a BAP control PDU.

Optionally, in the specific embodiment 1, if multiplexing resource information in the pre-scheduling information includes a starting time point of multiplexing scheduling, the starting time point of multiplexing scheduling is determined based on one of the following (1) to (3):

(1) A receiving time of a PDCCH, a MAC CE, or a BAP control PDU.

In other words, the starting time point of multiplexing scheduling corresponds to the receiving time of the PDCCH, the MAC CE, or the BAP control PDU, and optionally, corresponds to a starting or ending time point of a slot in which the PDCCH, MAC CE, or BAP control PDU is located.

For example, referring to FIG. 3, multiplexing scheduling between the first hop and the second hop takes effect in X slots after PDCCH reception, that is, multiplexing scheduling starts at a time that is X slots after PDCCH reception.

(2) A sending time of an acknowledgement signal corresponding to reception of the PDCCH, the MAC CE, or the BAP control PDU.

In other words, the starting time point of multiplexing scheduling corresponds to the sending time of an acknowledgement signal (ACK) corresponding to reception of the PDCCH, MAC CE, or BAP control PDU, and optionally, corresponds to a ending time point of a slot in which the sending time of the acknowledgement signal is located.

For example, referring to FIG. 4, multiplexing scheduling between the first hop and the second hop takes effect in X slots after sending of the acknowledgement signal, that is, multiplexing scheduling starts at a time that is X slots after the sending time of the acknowledgement signal.

(3) Indication information carried by the PDCCH, the MAC CE, or the BAP control PDU.

Optionally, the starting time point of multiplexing scheduling is determined based on indication displayed on the PDCCH, MAC CE, or BAP control PDU.

For example, the multiplexing scheduling based on the indication of the PDCCH is activated in X slots after PDCCH reception.

Optionally, the multiplexing scheduling method for IAB network according to this embodiment of the present invention may further include one of the following steps shown in (1) and (2).

(1) Send deactivation signaling to the first IAB node, where the deactivation signaling is used to indicate deactivating the multiplexing scheduling.

Optionally, the deactivation signaling may be carried by one of the following: a PDCCH, a MAC CE, and a BAP control PDU.

(2) Send, to the first IAB node, target scheduling information of the second IAB node on the second hop, where the target scheduling information is used by the first IAB node to determine whether to deactivate the multiplexing scheduling.

Optionally, the multiplexing scheduling method for IAB network in this embodiment of the present invention may further include an operation of deactivating the multiplexing scheduling between the first hop and the second hop. After the multiplexing scheduling is deactivated, multiplexing scheduling is no longer performed for the first IAB node and the second IAB node.

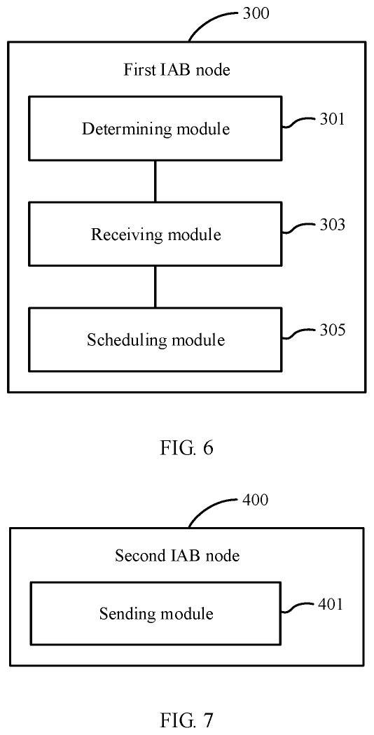

Referring to FIG. 6, an embodiment of the present invention provides a first IAB node 300. The first IAB node 300 includes a determining module 301, a receiving module 303, and a scheduling module 305.

The determining module 301 is configured to determine pre-scheduling information between a first hop and a second hop. The receiving module 303 is configured to receive activation signaling sent by a second IAB node. The scheduling module 305 is configured to, after activating multiplexing scheduling between the first hop and the second hop based on the activation signaling, perform multiplexing scheduling based on the pre-scheduling information, where the first IAB node is used to schedule data transmission on the first hop, and the second IAB node is a parent IAB node of the first IAB node and is used to schedule data transmission on the second hop.

Optionally, in the first IAB node 300 according to this embodiment of the present invention, the determining module 301 may be configured to: obtain the pre-scheduling information determined by the second IAB node.

Optionally, in the first IAB node 300 according to this embodiment of the present invention, the pre-scheduling information is carried by one of the following: a PDCCH, a MAC CE, and a BAP control PDU.

Optionally, in the first IAB node 300 according to this embodiment of the present invention, the determining module 301 may be configured to: obtain the pre-scheduling information configured by a centralized unit CU.

Optionally, in the first IAB node 300 according to this embodiment of the present invention, the pre-scheduling information is carried by one of the following: radio resource control RRC signaling or F1AP signaling.

Optionally, in the first IAB node 300 according to this embodiment of the present invention, the pre-scheduling information includes multiplexing resource information and a multiplexing manner.

Optionally, in the first IAB node 300 according to this embodiment of the present invention, the multiplexing resource information includes at least one of the following: a time length for using multiplexing scheduling; a frequency range for using multiplexing scheduling; and a starting time point of multiplexing scheduling.

Optionally, in the first IAB node 300 according to this embodiment of the present invention, in a case that the multiplexing resource information includes the starting time point of multiplexing scheduling, the starting time point of multiplexing scheduling is determined based on one of the following: a receiving time of a PDCCH, a MAC CE, or a BAP control PDU; a sending time of an acknowledgement signal corresponding to reception of the PDCCH, the MAC CE, or the BAP control PDU; and; and indication information carried by the PDCCH, the MAC CE, or the BAP control PDU.

Optionally, in the first IAB node 300 according to this embodiment of the present invention, the multiplexing manner includes one of the following: transmit or receive multiplexing based on spatial division multiplexing SDM; transmit or receive multiplexing based on frequency division multiplexing FDM; and transmit or receive multiplexing based on co-frequency co-time full duplex CCFD.

Optionally, in the first IAB node 300 according to this embodiment of the present invention, the pre-scheduling information further includes power control information.

Optionally, in the first IAB node 300 according to this embodiment of the present invention, the activation signaling is carried by one of the following: a PDCCH, a MAC CE, and a BAP control PDU.

Optionally, in the first IAB node 300 according to this embodiment of the present invention, the receiving module 303 may be further configured to: receive deactivation signaling sent by the second IAB node, where the deactivation signaling is used to indicate deactivating the multiplexing scheduling.

Optionally, in the first IAB node 300 according to this embodiment of the present invention, the deactivation signaling is carried by one of the following: a PDCCH, a MAC CE, and a BAP control PDU.

Optionally, the first IAB node 300 according to this embodiment of the present invention may further include a detection module, configured to determine whether to deactivate the multiplexing scheduling based on received target scheduling information of the second IAB node on the second hop.

Optionally, in the first IAB node 300 according to this embodiment of the present invention, the multiplexing scheduling is deactivated after bandwidth part BWP switching.

It can be understood that the first IAB node 300 according to this embodiment of the present invention can implement the multiplexing scheduling method for IAB network executed by the first IAB node 300. Descriptions about the multiplexing scheduling method for IAB network are all applicable to the first IAB node 300. Details are not described again herein.

In this embodiment of the present invention, in a self-backhaul loop of an IAB network, in a case that the first IAB node for scheduling the first hop determines the pre-scheduling information between the first hop and the second hop, the first IAB node may perform multiplexing scheduling between the first hop and the second hop based on the activation signaling received from its parent IAB node, that is, the second IAB node. The first IAB node may perform multiplexing scheduling based on the pre-scheduling information. This not only enriches manners of activating multiplexing scheduling across hops in the IAB network, but also helps determine interference on reception of the first IAB node. In this way, scheduling parameters can be accurately determined to further accurately determine a power distribution status on IAB nodes, thereby improving adaptive performance of a radio backhaul link, reducing transmission latency, and improving spectrum efficiency.

Referring to FIG. 7, an embodiment of the present invention provides a second IAB node 400. The second IAB node 400 includes: a sending module 401, configured to send activation signaling to a first IAB node, where the activation signaling is used by the first IAB node to activate multiplexing scheduling between a first hop and a second hop, the first IAB node is used to schedule data transmission on the first hop, and the second IAB node is a parent IAB node of the first IAB node and is used to schedule data transmission on the second hop.

Optionally, in the second IAB node 400 according to this embodiment of the present invention, the sending module 401 may be further configured to: before sending the activation signaling to the first IAB node, send pre-scheduling information to the first IAB node, where the pre-scheduling information is used to configure the first IAB node to perform multiplexing scheduling between the first hop and the second hop.

Optionally, in the second IAB node 400 according to this embodiment of the present invention, the activation signaling and the pre-scheduling information are carried by one of the following: a PDCCH, a MAC CE, and a BAP control PDU.

Optionally, in the second IAB node 400 according to this embodiment of the present invention, the sending module 401 may be further configured to: send deactivation signaling to the first IAB node, where the deactivation signaling is used to indicate deactivating the multiplexing scheduling; or send, to the first IAB node, target scheduling information of the second IAB node on the second hop, where the target scheduling information is used by the first IAB node to determine whether to deactivate the multiplexing scheduling.

Optionally, in the second IAB node 400 according to this embodiment of the present invention, the deactivation signaling is carried by one of the following: a PDCCH, a MAC CE, and a BAP control PDU.

It can be understood that the second IAB node 400 according to this embodiment of the present invention can implement the multiplexing scheduling method for IAB network executed by the second IAB node 400. Descriptions about the multiplexing scheduling method for IAB network are all applicable to the second IAB node 400. Details are not described again herein.

In this embodiment of the present invention, in a self-backhaul loop of an IAB network, in a case that the first IAB node for scheduling the first hop determines pre-scheduling information between the first hop and the second hop, a parent IAB node of the first IAB node, that is, the second IAB node, may send the activation signaling to the first IAB node so that the first IAB node activates the multiplexing scheduling between the first hop and the second hop based on the activation signaling. This not only enriches manners of activating multiplexing scheduling across hops in the IAB network, but also helps determine interference on reception of the first IAB node. In this way, scheduling parameters can be accurately determined to further accurately determine a power distribution status on IAB nodes, thereby improving adaptive performance of a radio backhaul link, reducing transmission latency, and improving spectrum efficiency.

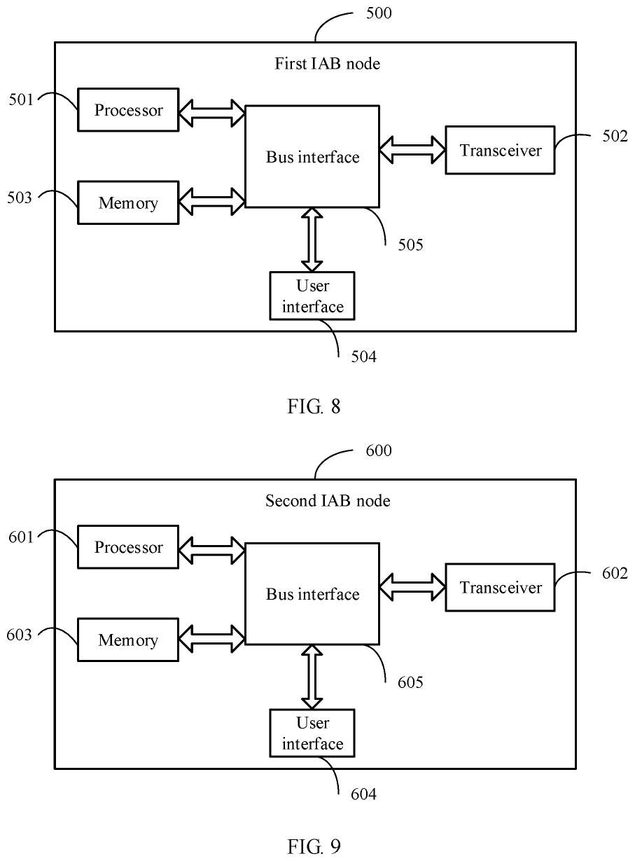

Referring to FIG. 8, FIG. 8 is a structural diagram of a first IAB node according to an embodiment of the present invention. The first IAB node is capable of implementing details of the multiplexing scheduling method for IAB network in the foregoing embodiments, with a same effect achieved. As shown in FIG. 8, the first IAB node 500 includes a processor 501, a transceiver 502, a memory 503, a user interface 504, and a bus interface 505. In this embodiment of the present invention, the first IAB node 500 further includes a computer program stored in the memory 503 and capable of running on the processor 501. When the computer program is executed by the processor 501, the following steps are implemented: determining pre-scheduling information between a first hop and a second hop; receiving activation signaling sent by a second IAB node; and after activating multiplexing scheduling between the first hop and the second hop based on the activation signaling, performing multiplexing scheduling based on the pre-scheduling information, where the first IAB node is used to schedule data transmission on the first hop, and the second IAB node is a parent IAB node of the first IAB node and is used to schedule data transmission on the second hop.

In FIG. 8, a bus architecture may include any quantity of interconnected buses and bridges, and specifically connect together various circuits of one or more processors represented by the processor 501 and a memory represented by the memory 503. The bus architecture may further interconnect various other circuits such as a peripheral device, a voltage regulator, and a power management circuit. These are all well known in the art, and therefore are not further described in this specification. The bus interface 505 provides an interface. The transceiver 502 may be a plurality of components, including a transmitter and a receiver, and provides units for communicating with a variety of other apparatuses on a transmission medium. For different user equipment, the user interface 504 may also be an interface capable of externally or internally connecting a required device, and the connected device includes but is not limited to a keypad, a display, a speaker, a microphone, a joystick, and the like.

The processor 501 is responsible for management of the bus architecture and general processing, and the memory 503 may store data for use by the processor 501 when the processor 501 performs an operation.

In this embodiment of the present invention, in a self-backhaul loop of an IAB network, in a case that the first IAB node for scheduling the first hop determines the pre-scheduling information between the first hop and the second hop, the first IAB node may perform multiplexing scheduling between the first hop and the second hop based on the activation signaling received from its parent IAB node, that is, the second IAB node. The first IAB node may perform multiplexing scheduling based on the pre-scheduling information. This not only enriches manners of activating multiplexing scheduling across hops in the IAB network, but also helps determine interference on reception of the first IAB node. In this way, scheduling parameters can be accurately determined to further accurately determine a power distribution status on IAB nodes, thereby improving adaptive performance of a radio backhaul link, reducing transmission latency, and improving spectrum efficiency.

Referring to FIG. 9, FIG. 9 is a structural diagram of a second IAB node according to an embodiment of the present invention. The first IAB node is capable of implementing details of the multiplexing scheduling method for IAB network in the foregoing embodiments, with a same effect achieved. As shown in FIG. 9, the second IAB node 600 includes a processor 601, a transceiver 602, a memory 603, a user interface 604, and a bus interface 605.

In this embodiment of the present invention, the second IAB node 600 further includes a computer program stored in the memory 603 and capable of running on the processor 601. When the computer program is executed by the processor 601, the following steps are implemented: sending activation signaling to a first IAB node, where the activation signaling is used by the first IAB node to activate multiplexing scheduling between a first hop and a second hop, the first IAB node is used to schedule data transmission on the first hop, and the second IAB node is a parent IAB node of the first IAB node and is used to schedule data transmission on the second hop.

In FIG. 9, a bus architecture may include any quantity of interconnected buses and bridges, and specifically connect together various circuits of one or more processors represented by the processor 601 and a memory represented by the memory 603. The bus architecture may further interconnect various other circuits such as a peripheral device, a voltage regulator, and a power management circuit. These are all well known in the art, and therefore are not further described in this specification. The bus interface 605 provides an interface. The transceiver 602 may be a plurality of components, including a transmitter and a receiver, and provides units for communicating with a variety of other apparatuses on a transmission medium. For different user equipment, the user interface 604 may also be an interface capable of externally or internally connecting a required device, and the connected device includes but is not limited to a keypad, a display, a speaker, a microphone, a joystick, and the like.

The processor 601 is responsible for management of the bus architecture and general processing, and the memory 603 may store data for use by the processor 601 when the processor 601 performs an operation.

In this embodiment of the present invention, in a self-backhaul loop of an IAB network, in a case that the first IAB node for scheduling the first hop determines pre-scheduling information between the first hop and the second hop, a parent IAB node of the first IAB node, that is, the second IAB node, may send the activation signaling to the first IAB node so that the first IAB node activates the multiplexing scheduling between the first hop and the second hop based on the activation signaling. This not only enriches manners of activating multiplexing scheduling across hops in the IAB network, but also helps determine interference on reception of the first IAB node. In this way, scheduling parameters can be accurately determined to further accurately determine a power distribution status on IAB nodes, thereby improving adaptive performance of a radio backhaul link, reducing transmission latency, and improving spectrum efficiency.

Preferably, an embodiment of the present invention further provides a first IAB node, including a processor, a memory, and a computer program stored in the memory and capable of running on the processor. When the computer program is executed by the processor, the processes of the multiplexing scheduling method for IAB network in the foregoing corresponding embodiments are implemented, with the same technical effects achieved. To avoid repetition, details are not described again herein.

An embodiment of the present invention further provides a computer-readable storage medium that stores a computer program. When the computer program is executed by a processor, the processes of the multiplexing scheduling method for IAB network applied to a first IAB node in the foregoing embodiments are implemented, with the same technical effect achieved. To avoid repetition, details are not described herein again. The computer-readable storage medium is, for example, a read-only memory (Read-Only Memory, ROM), a random access memory (RAM), a magnetic disk, or an optical disc.

Preferably, an embodiment of the present invention further provides a second IAB node, including a processor, a memory, and a computer program stored in the memory and capable of running on the processor. When the computer program is executed by the processor, the processes of the multiplexing scheduling method for IAB network in the foregoing corresponding embodiments are implemented, with the same technical effects achieved. To avoid repetition, details are not described again herein.

An embodiment of the present invention further provides a computer-readable storage medium that stores a computer program. When the computer program is executed by a processor, the processes of the multiplexing scheduling method for IAB network applied to a second IAB node in the foregoing embodiments are implemented, with the same technical effect achieved. To avoid repetition, details are not described herein again. The computer-readable storage medium is, for example, a read-only memory (ROM), a random access memory (RAM), a magnetic disk, or an optical disc.

It should be noted that in this specification, the term “comprise”, “include”, or any other variant thereof is intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element.

According to the description of the foregoing implementations, persons skilled in the art can clearly understand that the method in the foregoing embodiments may be implemented by software in addition to a necessary universal hardware platform or by hardware only. In most cases, the former is a more preferred implementation. Based on such an understanding, the technical solutions of the present invention essentially, or the part contributing to the prior art may be implemented in a form of a software product. The software product is stored in a storage medium (for example, ROM/RAM, a magnetic disk, or an optical disc), and includes several instructions for instructing a terminal (which may be a mobile phone, a computer, a server, an air conditioner, a network device, or the like) to perform the method described in the embodiments of the present invention.

The embodiments of the present invention are described above with reference to the accompanying drawings, but the present invention is not limited to the foregoing implementations. The foregoing embodiments are only illustrative rather than restrictive. Inspired by the present invention, a person of ordinary skill in the art can still derive many variations without departing from the essence of the present invention and the protection scope of the claims. All these variations shall fall within the protection of the present invention.

What is claimed is:

1. A multiplexing scheduling method for IAB network applied to a first IAB node, wherein the method comprises:
determining pre-scheduling information between a first hop and a second hop;
receiving activation signaling sent by a second IAB node; and
after activating multiplexing scheduling between the first hop and the second hop based on the activation signaling, performing multiplexing scheduling based on the pre-scheduling information, wherein the first IAB node is used to schedule data transmission on the first hop, and the second IAB node is a parent IAB node of the first IAB node and is used to schedule data transmission on the second hop.

2. The method according to claim 1, wherein the determining pre-scheduling information between a first hop and a second hop comprises:
obtaining the pre-scheduling information determined by the second IAB node.

3. The method according to claim 2, wherein the pre-scheduling information is carried by one of the following:
a physical downlink control channel PDCCH;
a medium access control control element MAC CE; and
a backhaul adaptation protocol BAP control protocol data unit PDU.

4. The method according to claim 1, wherein the determining pre-scheduling information between a first hop and a second hop comprises:
obtaining the pre-scheduling information configured by a centralized unit CU.

5. The method according to claim 4, wherein the pre-scheduling information is carried by one of the following: radio resource control RRC signaling or FLAP signaling.

6. The method according to claim 1, wherein the pre-scheduling information comprises multiplexing resource information and a multiplexing manner.

7. The method according to claim 6, wherein the multiplexing resource information comprises at least one of the following:
a time length for using multiplexing scheduling;
a frequency range for using multiplexing scheduling; and
a starting time point of multiplexing scheduling.

8. The method according to claim 7, wherein in a case that the multiplexing resource information comprises the starting time point of multiplexing scheduling, the starting time point of multiplexing scheduling is determined based on one of the following:
a receiving time of a PDCCH, a MAC CE, or a BAP control PDU;
a sending time of an acknowledgement signal corresponding to reception of the PDCCH, the MAC CE, or the BAP control PDU; and
indication information carried by the PDCCH, the MAC CE, or the BAP control PDU.

9. The method according to claim 6, wherein the multiplexing manner comprises one of the following:
transmit or receive multiplexing based on spatial division multiplexing SDM;
transmit or receive multiplexing based on frequency division multiplexing FDM; and
transmit and receive multiplexing based on co-frequency co-time full duplex CCFD.

10. The method according to claim 6, wherein the pre-scheduling information further comprises power control information.

11. The method according to claim 1, wherein the activation signaling is carried by one of the following:
a physical downlink control channel PDCCH;
a medium access control control element MAC CE; and
a BAP control PDU.

12. The method according to claim 1, wherein the method further comprises:
receiving deactivation signaling sent by the second IAB node, wherein the deactivation signaling is used to indicate deactivating the multiplexing scheduling.

13. The method according to claim 12, wherein the deactivation signaling is carried by one of the following:
a physical downlink control channel PDCCH;
a medium access control control element MAC CE; and
a BAP control PDU.

14. The method according to claim 1, wherein the method further comprises:
determining, based on received target scheduling information of the second IAB node on the second hop, whether to deactivate the multiplexing scheduling; or
wherein the multiplexing scheduling is deactivated after bandwidth part BWP switching.

15. A multiplexing scheduling method for IAB network applied to a second IAB node, wherein the method comprises:
sending activation signaling to a first IAB node, wherein the activation signaling is used by the first IAB node to activate multiplexing scheduling between a first hop and a second hop, the first IAB node is used to schedule data transmission on the first hop, and the second IAB node is a parent IAB node of the first IAB node and is used to schedule data transmission on the second hop.

16. The method according to claim 15, wherein before the sending activation signaling to a first IAB node, the method further comprises:
sending pre-scheduling information to the first IAB node, wherein the pre-scheduling information is used to configure the first IAB node to perform multiplexing scheduling between the first hop and the second hop.

17. The method according to claim 16, wherein the activation signaling and the pre-scheduling information are carried by one of the following:
a physical downlink control channel PDCCH;
a medium access control control element MAC CE; and
a BAP control PDU.

18. The method according to claim 15, wherein the method further comprises one of the following:
sending deactivation signaling to the first IAB node, wherein the deactivation signaling is used to indicate deactivating the multiplexing scheduling; or
sending, to the first IAB node, target scheduling information of the second IAB node on the second hop, wherein the target scheduling information is used by the first IAB node to determine whether to deactivate the multiplexing scheduling.

19. A first IAB node, comprising a memory, a processor, and a computer program stored in the memory and capable of running on the processor, wherein when the computer program is executed by the processor, the processor is configured to:
determine pre-scheduling information between a first hop and a second hop;
receive activation signaling sent by a second IAB node; and
after activating multiplexing scheduling between the first hop and the second hop based on the activation signaling, perform multiplexing scheduling based on the pre-scheduling information, wherein the first IAB node is used to schedule data transmission on the first hop, and the second IAB node is a parent IAB node of the first IAB node and is used to schedule data transmission on the second hop.

20. A second IAB node, comprising a memory, a processor, and a computer program stored in the memory and capable of running on the processor, wherein when the computer program is executed by the processor, the processor is configured to perform the steps of the method according to claim 15.
